(19) United States
(12) Patent Application Publication
(10) Pub. No.: US 2004/0086634 A1
(43) Pub. Date: May 6, 2004

(54) Method of deciding coating condition in manufacturing magnetic recording medium and magnetic recording medium

(75) Inventors: Toshihiro Mandai, Odawara-shi (JP); Mikio Tomaru, Odawara-shi (JP); Hideaki Takekuma, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/608,738

(22) Filed: Jun. 30, 2003

Related U.S. Application Data
(62) Division of application No. 10/160,226, filed on Jun. 4, 2002.

(30) Foreign Application Priority Data
Jun. 6, 2001 (JP) NO.2001-171107

(51) Int. Cl. B05D 5/12

(52) U.S. Cl. 427/127

(57) ABSTRACT

In manufacturing of a magnetic recording medium by using an extrusion-type coating method of extruding a coating liquid from an end of a slit of a coating head and applying the coating liquid to a continuously-running flexible support while making the flexible support relatively approach the end of the coating head so as to apply a magnetic coating liquid obtained by dispersing magnetic particles in a solvent on the flexible support to form a magnetic-coating-liquid layer, the quality of the coating condition is evaluated in accordance with shearing energy E for unit volume of the magnetic-coating-liquid layer obtained by

$$E = \frac{μ \cdot L \cdot V}{4 \cdot {t}^{ 2}} ,$$

where μ is viscosity (Pa.sec) of the magnetic coating liquid at shearing velocity of 10⁵ sec⁻¹, L is length (m) of a flexible support opposite face at downstream side of the slit at the end of the coating head, V is running velocity (m/sec) of the flexible support, and t is wet-coating thickness (m) of the magnetic-coating-liquid layer. Then, the coating condition is decided in accordance with the evaluation result. It is thus possible to suppress and break coagulation of the magnetic particles in the magnetic coating liquid, so that a preferable magnetic-layer surface can be obtained.

### BACKGROUND OF THE INVENTION

1. Field of the Invention

The present invention relates to a method of deciding a coating condition in manufacturing a magnetic recording medium and a magnetic recording medium, particularly to a method of deciding a coating condition in manufacturing a magnetic recording medium obtained by at least applying a coating liquid obtained by dispersing magnetic particles in a solvent to a flexible support (hereafter referred to as “web”) such as a plastic film, paper, or a metallic foil and forming a magnetic coating-liquid layer and a magnetic recording medium.

2. Description of the Related Art

A magnetic recording medium such as a magnetic recording tape has been rapidly improved in capacity and recording density so as to be used for broadcast and computers in recent years and film formation is requested so that a magnetic layer for recording data is very thin and uniform and the surface of the magnetic layer is smooth.

To apply a coating liquid to the surface of a web, for example, the following methods are used: a roller coater method, a gravure coating method, a roller-coating plus doctor method, an extrusion-type coating method, and a slide-coating type coating method or the like. The extrusion-type coating method has been frequently used for coating of a magnetic coating liquid in recent years. In the case of the extrusion-type coating method, a coating liquid is applied to a continuously-running web by extruding the coating liquid from the end of a slit of a coating head while making the web relatively approach the end of the coating head and thereby, a uniform very-thin magnetic coating-liquid layer can be obtained. Moreover, it is possible to obtain a uniform very-thin magnetic layer and greatly improve a recording capacity by using the coating head disclosed in Japanese Patent No. 2581975, thereby applying a non-magnetic coating liquid onto a web, and thereafter applying a magnetic coating liquid over the non-magnetic coating liquid before the non-magnetic coating liquid is dried. However, there is a problem that particles form agglomerates due to the magnetic attraction between particles as the characteristic of a magnetic coating liquid and the agglomerates causes irregularity of the coating film surface, and deteriorates the electromagnetic conversion characteristic.

As an improvement of a conventional extrusion-type coating method, Japanese Patent No. 2645613 discloses applying a coating liquid so that a flow index A obtained from A=Γ·L/V becomes 100 or more when assuming the length of a doctor lip face (also referred to as doctor edge face) in the running direction of a web as L, the average flow velocity of a coating liquid on the doctor lip face as V, and the shearing velocity of the coating liquid on the doctor lip face as Γ. Moreover, Japanese Patent Application Publication No. 11-203676 discloses applying a magnetic paint onto a web at a sharing rate of 1.5×10⁵ (sec⁻¹) or more. Furthermore, Japanese Patent Publication No. 7-114998 discloses constituting a die so that the radius of curvature of the downstream lip face of the die ranges between 4 and 20 mm and the length of the circular arc of a downstream lip in the web direction ranges between 2 and 7 mm at the time of multilayer-applying the two layers.

However, as information-related fields develop, a recording medium having a larger recording capacity and a higher recording density is requested. Therefore, there is a problem that a coating layer having a surface characteristic preferable enough to meet an electromagnetic conversion characteristic cannot be obtained even if using the above conventional coating method and system. The surface characteristic of the surface of a coating layer is slightly improved through a calender treatment performed after coating. However, because the calender treatment is restricted, it is basically necessary to obtain a preferable coating-layer surface in a coating process.

### SUMMARY OF THE INVENTION

The present invention is achieved to solve the above problems and its object is to provide a method of deciding a coating condition in manufacturing a magnetic recording medium capable of clarifying factors for suppressing and breaking the coagulation of magnetic particles and obtaining a preferable magnetic layer in a coating process at the time of applying a magnetic coating liquid in accordance with the extrusion-type coating method and a magnetic recording medium.

To attain the above object, the present invention is directed to a method of deciding a coating condition in manufacturing of a magnetic recording medium by using an extrusion-type coating method of extruding a coating liquid from a end of a slit of a coating head and applying the coating liquid to a flexible support while making the flexible support relatively approach the end of the coating head so as to apply in a single layer a magnetic coating liquid obtained by dispersing magnetic particles in a solvent, the method comprising the steps of: evaluating quality of the coating condition in accordance with shearing energy E for unit volume of a magnetic-coating-liquid layer obtained by

$$E = \frac{μ \cdot L \cdot V}{4 \cdot {t}^{ 2}} ,$$

where μ is viscosity (Pa.sec) of the magnetic coating liquid at shearing velocity of 10⁵ sec⁻¹, L is length (m) of a flexible support opposite face at downstream side of the slit at the end of the coating head, V is running velocity (m/sec) of the flexible support, and t is wet-coating thickness (m) of the magnetic-coating-liquid layer; and deciding the coating condition in accordance with a result of the evaluating step.

According to the present invention, the shearing energy E applied to the unit volume of the magnetic-coating-liquid layer at the end of the coating head is used as an index for improving the surface characteristic of the magnetic-coating-liquid layer applied to and formed on the flexible support at the time of applying the magnetic coating liquid obtained by dispersing magnetic particles in the solvent to the flexible support in accordance with the extrusion-type coating method. Specifically, the quality of the coating condition is evaluated in accordance with the shearing energy E for unit volume of the magnetic-coating-liquid layer obtained from the above formula and the coating condition is decided in accordance with the evaluation result.

The present inventors find that the surface roughness of a magnetic-coating-liquid layer and shearing energy E form an inversely-proportional linear relation and have a close correlation and obtains the information that it is possible to accurately evaluate the quality of a coating condition in accordance with the shearing energy E for unit volume of the magnetic-coating-liquid layer obtained from the above formula and accurately improve the surface roughness of the magnetic-coating-liquid layer by deciding a coating condition in accordance with the evaluation result. Though an allowable surface roughness slightly depends on the product type of magnetic recording medium, an allowable value of the surface roughness of a magnetic-coating-liquid layer capable of obtaining a performance satisfactory enough as a recording medium is 20 nm or less. To satisfy the allowable value, it is preferable that shearing energy E exceeds 3×10⁶. Therefore, by deciding a coating condition so that an evaluation result satisfies the shearing energy E>3×10⁶, it is possible to obtain a preferable magnetic-coating-liquid-layer surface in a coating process.

As a reason why the surface characteristic of a magnetic-coating-liquid layer is improved by specifying the shearing energy E for unit volume of the magnetic-coating-liquid layer, it is estimated that coagulation of magnetic particles is suppressed and breakdown of the coagulation is accelerated by applying a large shearing energy E to the magnetic-coating-liquid layer and applying a large shearing stress to a coating liquid because deterioration of the surface characteristic of the magnetic-coating-liquid layer is mainly caused by the coagulation of magnetic particles in a magnetic coating liquid.

The present is also directed to a method of deciding a coating condition in manufacturing of a magnetic recording medium by using an extrusion-type coating method of extruding coating liquids from ends of slits of a coating head and applying the coating liquids to a continuously-running flexible support while making the flexible support relatively approach an end of the coating head so as to apply a non-magnetic coating liquid obtained by dispersing non-magnetic particles in a solvent on the flexible support to form a non-magnetic lower layer and apply, before the non-magnetic lower layer is dried, a magnetic coating liquid obtained by dispersing magnetic particles in a solvent on the non-magnetic lower layer to form a magnetic upper layer, the method comprising the steps of evaluating quality of the coating condition in accordance with shearing energy E for unit volume of the magnetic upper layer obtained by

$$\begin{matrix}E = \frac{{μ}_{2} \cdot L \cdot {V}_{c}^{3}}{4 \cdot {t}_{2}^{ 2} \cdot {V}^{2}} , & ( 1 ) \\ {V}_{c} = \frac{V}{\sqrt{( 1 + α \cdot {t}_{1} / {t}_{2} )}} , and & ( 2 ) \\ α = {μ}_{2} / {μ}_{1} , & ( 3 )\end{matrix}$$

where μ₁ is viscosity (Pa.sec) of the non-magnetic coating liquid at shearing velocity of 10⁵ sec⁻¹, μ₂ is viscosity (Pa.sec) of the magnetic coating liquid at shearing velocity of 10⁵ sec⁻¹, L is length (m) of a flexible support opposite face at downstream side of the slit discharging the magnetic coating liquid at the end of the coating head, V is running velocity (m/sec) of the flexible support, t₁ is wet-coating thickness (m) of the non-magnetic lower layer, and t₂ is wet-coating thickness (m) of the magnetic upper layer; and deciding the coating condition in accordance with a result of the evaluation step.

According to the present invention, the shearing energy E for unit volume of the magnetic upper layer as an index for improving the surface characteristic of the magnetic upper layer for forming a layer on the surface of the previously coated layer in the multilayer coating to apply the non-magnetic coating liquid (lower-layer coating liquid) obtained by dispersing the non-magnetic particles in the solvent and the magnetic coating liquid (upper-layer coating liquid) obtained by dispersing the magnetic particles in the solvent to the flexible support through wet-on-wet in multiple layers. Specifically, the quality of coating condition is evaluated in accordance with the shearing energy E for unit volume of the magnetic upper layer obtained from the above formulas (1), (2) and (3), and a coating condition is decided in accordance with the evaluation result. That is, also in the case of the multilayer coating, an inversely-proportional linear relation is effectuated in the relation between the surface roughness of a magnetic upper layer and shearing energy E. Moreover, in the case of the multilayer coating, the allowable value of the surface roughness of a magnetic upper layer capable of obtaining a sufficient performance as a magnetic recording medium is 20 nm or less and it is preferable that shearing energy E exceeds 3×10⁶ in order to satisfy the allowable value. Therefore, in the case of the multilayer coating, it is possible to obtain a preferable magnetic upper layer in a coating process by deciding a coating condition so that an evaluation result satisfies shearing energy E>3×10⁶.

Moreover, the present invention is also directed to a magnetic recording medium coated so as to satisfy the coating condition of shearing energy E>3×10⁶ in accordance with the above-described costing-condition deciding methods.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a conceptual view of an extrusion-type coater for single-layer coating to which the present invention is applied;

FIG. 2 is a schematic view of an end of a coating head for single-layer coating;

FIG. 3 is a conceptual view of an extrusion-type coater for multilayer coating to which the present invention is applied;

FIG. 4 is a schematic view of an end of a coating head for multilayer simultaneous coating;

FIG. 5 is a conceptual view of a modification of an extrusion-type coater for multilayer coating, which is a type using two coating heads;

FIG. 6 is a table showing coating-test results for explaining a logical ground of the present invention; and

FIG. 7 is a graph showing a relation between shearing energy E and surface roughness, which explains a logical ground of the present invention.

### DETAILED DESCRIPTION OF THE PREFERRED EMBODIMENTS

A method of deciding a coating condition in manufacturing a magnetic recording medium and a preferable embodiment of a magnetic recording medium of the present invention will be described below by referring to the accompanying drawings.

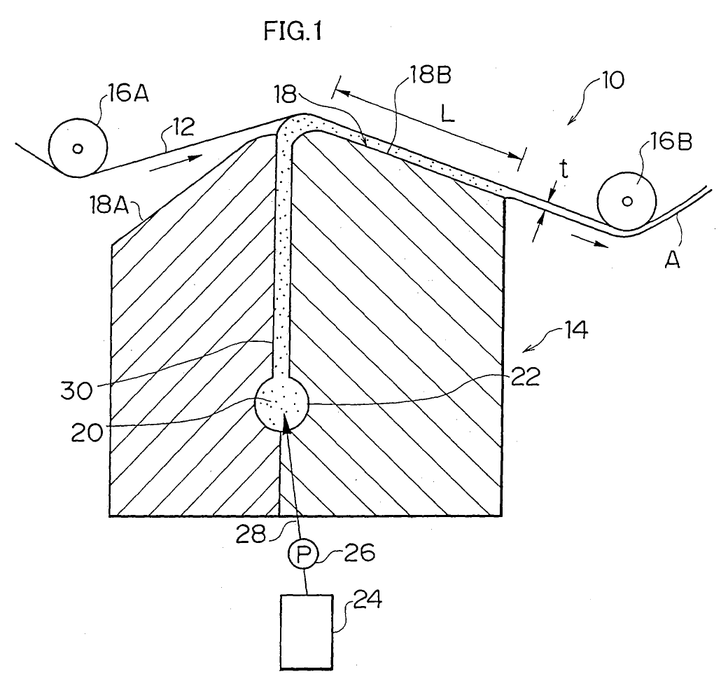

FIG. 1 is a conceptual illustration for explaining a first embodiment of an extrusion-type coater to which a method of the present invention of deciding a coating condition in manufacturing a magnetic recording medium is applied at the time of single-layer-applying a magnetic layer to a web.

As shown in FIG. 1, a coater 10 is mainly constituted by a web 12 which continuously runs in the direction of the arrow, a coating head 14 for applying a coating liquid to the web 12, and a pair of guide rollers 16A and 16B for mounting the continuously-running web 12, the pair of guide rollers 16A and 16B being respectively provided at the upstream and downstream of a web running direction centering around the coating head 14.

A cylindrical pocket section 22 parallel with the width direction of the web 12 is formed in the coating head 14 and the pocket section 22 and a coating-liquid tank 24 are connected with each other by a pipe 28 through a fixed-quantity-of-liquid feed pump 26. Moreover, a slit 30 communicating with the pocket section 22 and extending to a lip face 18 is formed on the coating head 14. In the case of the lip face 18 formed at the end of the coating head 14, a front lip face 18A is formed centering around the slit 30 at the upstream side of the web running direction and a doctor lip face 18B is formed at the downstream side. Moreover, a magnetic coating liquid 20 obtained by dispersing magnetic particles in a solvent is supplied from the coating-liquid tank 24 to the pocket section 22 and expanded to a width corresponding to a coating width, raised on the slit 30 and discharged, and applied to the continuously-running web 12 while making the web 12 relatively approach the end of the coating head 14. Thereby, a magnetic-coating-liquid layer A is formed on the web face in a single layer.

To form the magnetic-coating-liquid layer A on the web face 12 in a single layer by the coater 10 constituted as described above, whether a coating condition is proper is evaluated in accordance with shearing energy E obtained by

$$E = \frac{μ \cdot L \cdot V}{4 \cdot {t}^{ 2}} ,$$

where μ is viscosity (Pa.sec) of the magnetic coating liquid 20 at shearing velocity of 10⁵ sec⁻¹, L is length (m) of a web opposite face at downstream side of the slit 30 on the end of the coating head 14, V is running velocity (m/sec) of the web 12, and t is wet-coating thickness (m) of the magnetic-coating-liquid layer A.

When the shearing energy E exceeds 3×10⁶, the coating condition is evaluated to be proper and coating is executed in accordance with the coating condition. However, if the shearing energy E is 3×10⁶ or less, the coating condition is evaluated to be improper and the coating-condition factors μ, L, V, and t are reset so that the shearing energy E exceeds 3×10⁶. Thereby, it is possible to obtain a magnetic recording medium coated so as to satisfy the coating condition of the shearing energy E>3×10⁶.

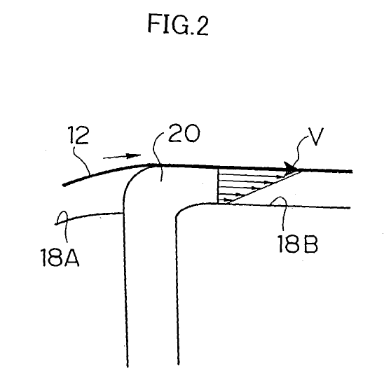

In the case of single-layer coating, it is estimated that the shearing-speed distribution between the end of the coating head and the web 12 appears as the distribution shown by a schematic view in FIG. 2. Moreover, the shearing energy E is considered as the product between a shearing stress for unit volume applied to the magnetic coating liquid 20 and a length to which the shearing stress is applied between the end of the coating head and the web 12 and the above formula is obtained by deforming the product.

To increase the shearing energy E, it is effective to increase the viscosity (μ) of the magnetic coating liquid 20 at the shearing speed of 10⁵ sec⁻¹, increase the length of the web opposite face at the downstream side of the slit on the end of the coating head 14, that is, the length (L) of the doctor lip face 18B, and increase the running velocity (V) of the web 12 while decreasing the wet-coating thickness (t) of the magnetic-coating-liquid layer A. To perform preferable coating free from uneven ribs under the above conditions, it is necessary to properly adjust the relation between the shape of the coating head 14, the gap value of the slit 30, the coating pressure of the coating liquid 20 discharged from the slit 30, and the pressure for relatively pressing the lip face 18 of the coating head 14 and the web 12. Moreover, in the case of the so-called wet-on-dry method of previously applying an undercoating layer on the surface of the web 12 and drying the layer and then applying the magnetic coating liquid 20 by one layer, it is possible to regard the web 12 including the undercoating layer previously applied and dried as the web 12 and apply the present invention to the web 12.

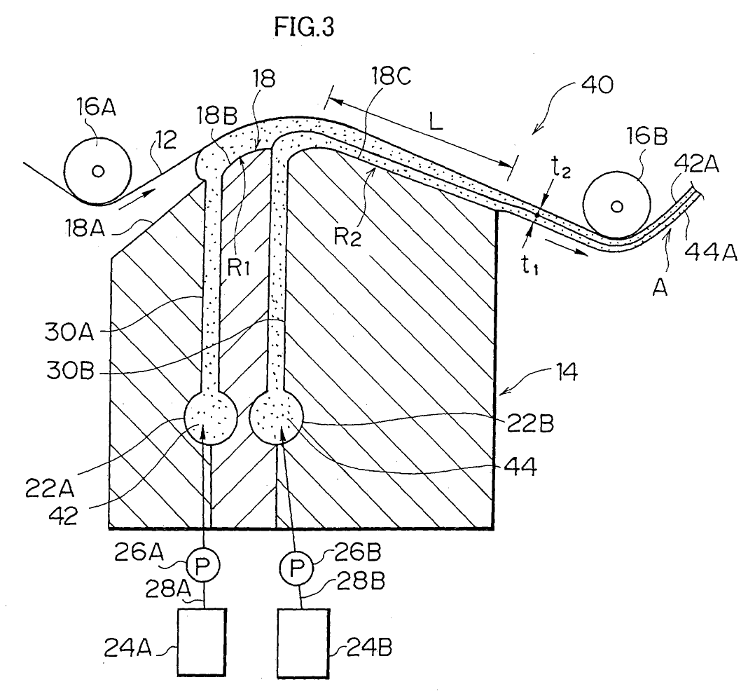

FIG. 3 is a conceptual illustration for explaining second embodiment of an extrusion-type coater to which a method of deciding a coating condition in manufacturing of a magnetic recording medium of the present invention is applied, showing a case of multilayer-applying a non-magnetic lower layer and a magnetic upper layer to a web.

As shown in FIG. 3, a multilayer-applying coater 40 basically has the same configuration as the configuration described for the first embodiment and is constituted so as to be able to apply a non-magnetic coating liquid (lower-layer coating liquid at the side contacting a web 12) and a magnetic coating liquid (upper-side coating liquid to coat over the non-magnetic lower layer) to the web 12 at the same time. A member same as the case of the first embodiment is provided with the same symbol.

That is, two cylindrical pocket sections 22A and 22B parallel with the width direction of the web 12 are formed in a coating head 14 and the pocket sections 22A and 22B are connected with coating-liquid tanks 24A and 24B for storing a non-magnetic coating liquid 42 and a magnetic coating liquid 44 by pipes 28A and 28B through a fixed-quantity-of-liquid feed pumps 26A and 26B, respectively. Moreover, two slits 30A and 30B communicating with the pocket sections 22A and 22B and extending to a lip face 18 are formed on the coating head 14. On the lip face 18 formed at the end of the coating head 14, a front lip face 18A, first doctor lip face 18B, and second doctor lip face 18C are formed in order from the upstream side of a web running direction at the both sides of slits 30A and 30B. Moreover, the non-magnetic coating liquid 42 and magnetic coating liquid 44 are supplied from the coating-liquid tanks 24A and 24B to their respective pocket sections 22A and 22B, expanded to widths corresponding to a coating width, then rise through the slits 30A and 30B and are discharged and applied to the web 12 while making the continuously-running web 12 relatively approach the lip face 18 of the coating head 14. Thereby, a multi-coating layer A constituted by a non-magnetic lower layer 42A coated with the non-magnetic coating liquid 42 obtained by dispersing non-magnetic particles in a solvent and a magnetic upper layer 44A coated with the magnetic coating liquid 44 obtained by dispersing magnetic particles in a solvent is formed on the surface of the web 12.

To form the multi-coating layer A on the surface of the web 12 by the coater 40 constituted as described above, whether a coating condition is proper is evaluated in accordance with shearing energy E obtained from the following formulas (1), (2), and (3):

$$\begin{matrix}E = \frac{{μ}_{2} \cdot L \cdot {V}_{c}^{3}}{4 \cdot {t}_{2}^{ 2} \cdot {V}^{2}} , & ( 1 ) \\ {V}_{c} = \frac{V}{\sqrt{( 1 + α \cdot {t}_{1} / {t}_{2} )}} , and & ( 2 ) \\ α = {μ}_{2} / {μ}_{1} , & ( 3 )\end{matrix}$$

where μ₁ is viscosity (Pa.sec) of the non-magnetic coating liquid 42 at shearing velocity of 10⁵ sec⁻¹, μ₂ is viscosity (Pa.sec) of the magnetic coating liquid 44 at shearing velocity of 10⁵ sec⁻¹, L is length (m) of a web opposite face at downstream side of the slit 30B for discharging the magnetic coating liquid 44 at the end of the coating head 14, V is running velocity (n/sec) of the web 12, t₁ is wet-coating thickness (m) of the non-magnetic lower layer 42A, and t₂ is wet-coating thickness (m) of the magnetic upper layer 44A.

When the shearing energy E exceeds 3×10⁶, the coating condition is evaluated to be proper and coating is performed in accordance with the coating condition. However, if the shearing energy E is 3×10⁶ or less, the coating condition is evaluated to be improper and conditions of coating-condition factors μ₁, μ₂, L, V, t₁, and t₂ are reset so that the shearing energy E exceeds 3×10⁶. Thereby, also when multilayer-applying a non-magnetic lower layer and a magnetic upper layer to a web, it is possible to obtain a magnetic recording medium coated so as to satisfy the coating condition of shearing energy E>3×10⁶.

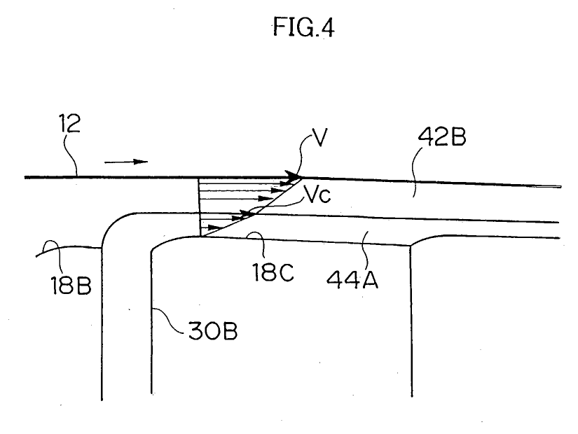

In the case of multilayer coating, it is estimated that the shearing-velocity distribution between the end of a coating head and the web 12 becomes the distribution shown by the schematic view in FIG. 4. Because a non-magnetic lower layer 42B having a flowability between the magnetic upper layer 44A and the web 12 is present, the shearing stress applied to the magnetic upper layer 44A decreases compared to the case of single-layer coating. The shearing energy E applied to the magnetic coating liquid 44 for unit volume at the end of the coating head relates to the length of the web opposite face at the downstream side of the slit 30B for extruding the magnetic coating liquid 44, that is, the length (L) of a second doctor lip face 18C and the coating velocity (V) and moreover, the viscosity ratio (α) between upper and lower layers and the ratio (t₁/t₂) between wet-coating thicknesses of upper and lower layers, which can be obtained by using the above formulas (1), (2), and (3).

The formula (1) is a formula for obtaining the shearing energy E applied to the magnetic coating liquid 44 for unit volume, the formula (2) is a formula for obtaining the velocity Vc of a liquid at the interface between the non-magnetic lower layer 42A and the magnetic upper layer 44A, and the formula (3) is a formula for obtaining the viscosity ratio between the viscosity μ₁ of the non-magnetic coating liquid 42 at the shearing velocity of 10⁵ sec⁻¹ and the viscosity μ₂ of the magnetic coating liquid 44 at the shearing velocity of 10⁵ sec⁻¹. Moreover, to increase the shearing energy E, it is preferable to increase L and decrease the ratio (t₁/t₂) between wet thicknesses and decrease the viscosity ratio (μ₂/μ₁).

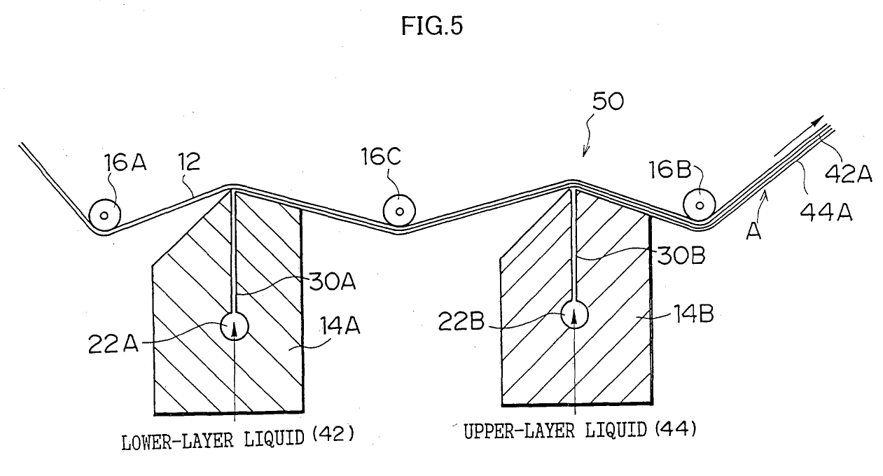

FIG. 5 is a modification of the second embodiment of a coater 50 to which the present invention is applied, showing a case of setting the coating heads 14A and 14B to the upstream side and downstream side of the web running direction respectively, first applying the non-magnetic coating liquid 42 by the upstream-side coating head 14A to form the non-magnetic lower layer 42A and then applying the magnetic coating liquid 44 over the non-magnetic lower layer 42A before the non-magnetic lower layer 42 is dried to form the magnetic upper layer 44A. Also in this case, it is possible to apply a method of the present invention for manufacturing a magnetic recording medium.

### EXAMPLE

A coating test was performed of simultaneously applying a non-magnetic coating liquid and a magnetic coating liquid to a web by using an extrusion-type coater provided with the coating head for simultaneous multilayer coating described in FIG. 3.

Table 1 shows the composition of components of a magnetic coating liquid, and Table 2 shows the composition of components of a non-magnetic coating liquid.

TABLE 1

| Components of magnetic coating liquid | Parts by weight |
|---|---|
| Fe/Zn/Ni powder | 300 |
| Vinyl chloride-vinyl acetate copolymer | 30 |
| Conductive carbon | 20 |
| Polyamide resin | 15 |
| Lecithin | 6 |
| Cyclohexane | 300 |
| Methyl ethyl ketone | 300 |
| n-butanol | 100 |

TABLE 2

| Components of non-magnetic coating liquid | Parts by weight |
|---|---|
| TiO₂ powder | 300 |
| Vinyl chloride-vinyl acetate copolymer | 30 |
| Conductive carbon | 20 |
| Polyamide resin | 15 |
| Lecithin | 6 |
| Cyclohexane | 500 |
| n-butanol | 100 |

Solutions obtained by putting materials of the component compositions in Tables 1 and 2 in different ball mills respectively and sufficiently mixing and dispersing them and then, adding 30 parts by weight of epoxy resin and adding a methyl ethyl ketone so that a desired viscosity was obtained and sufficiently mixing them were used as a magnetic coating liquid and a non-magnetic coating liquid.

The magnetic and non-magnetic coating liquids were applied by using a PET (polyethylene terephthalate) film having a thickness of 15 μm so that the coating velocity became 200 to 400 m/min. Moreover, the slit gap value of a coating head was set to 0.15 mm for each slit and the shape of an edge face was set as shown below:

Radius of curvature R₁ of first doctor-lip face: 3 mm

Length of first doctor-lip face: 1 mm

Radius of curvature R₂ of second doctor lip face: 3 mm

Length of second doctor-lip face: 3-10 mm

Moreover, the relation between the shearing energy E for unit volume of a magnetic upper layer and the roughness of the surface of the magnetic upper layer was examined when changing conditions of coating factors such as the viscosity (μ₁) of the non-magnetic coating liquid (lower-layer liquid) at the shearing velocity of 10⁵ sec⁻¹, the viscosity (μ₂) of the magnetic coating liquid (upper-layer liquid) at the shearing velocity of 10⁵ sec⁻¹, the length (L) of the second doctor lip face, web running velocity (V), the wet-coating thickness (t₁) of the non-magnetic lower layer (lower-layer coating), and the wet-coating thickness (t₂) of the magnetic upper layer (upper-layer coating).

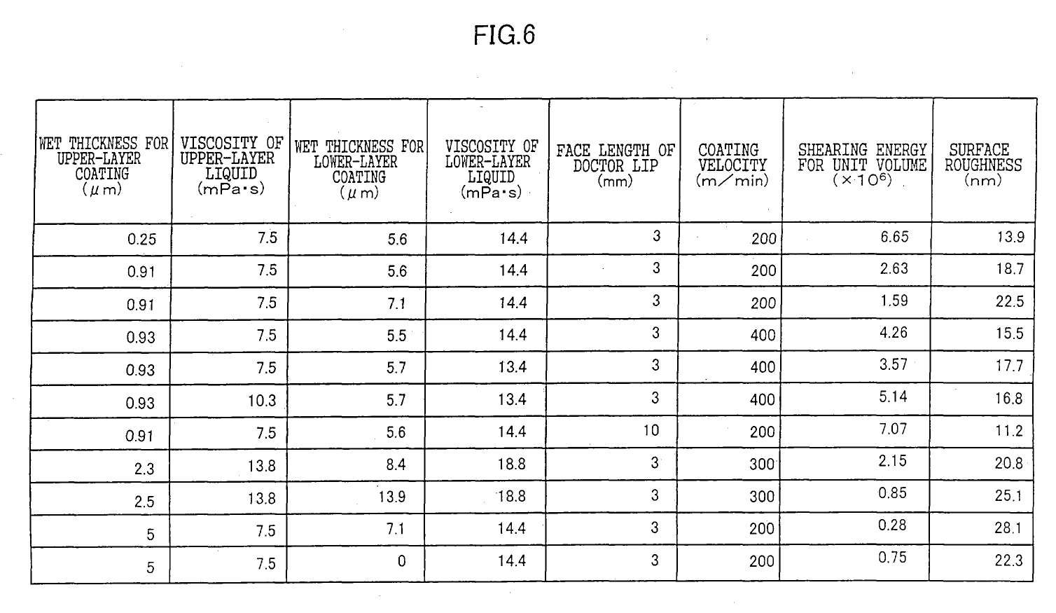

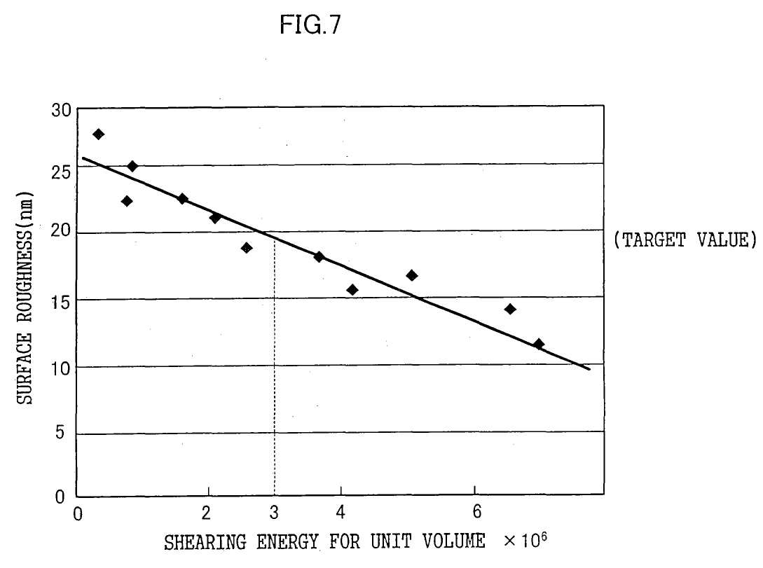

FIGS. 6 and 7 show coating-test results.

FIG. 6 is a table showing shearing energy E and surface roughness when changing set conditions of each coating factor, and FIG. 7 is a graph showing the relation between shearing energy E and surface roughness.

As shown in FIG. 7, each of plots showing the relation between surface roughness and shearing energy E when changing set conditions of each coating factor accurately rides on an inversely-proportional line. This denotes that the surface roughness of a magnetic layer closely relates to the shearing energy E and the surface roughness decreases as the shearing energy E increases. Therefore, it is possible to accurately improve the surface roughness of a magnetic upper layer by increasing the shearing energy E. Moreover, it is preferable that an allowable value of surface roughness capable of obtaining a performance satisfactory enough as a magnetic recording medium is 20 nm or less and at the time of considering the dispersion of the plots to the inversely-proportional line, the condition of each coating factor is set so that shearing energy E exceeds 3×10⁶.

As described above, according to a method of deciding a coating condition in manufacturing a magnetic recording medium and a magnetic recording medium of the present invention, it is possible to suppress and break the coagulation of magnetic particles at the time of applying a magnetic coating liquid in accordance with the extrusion-type coating method. Therefore, it is possible to obtain a preferable magnetic-layer surface in a coating process. Moreover, it is possible to obtain a magnetic recording medium having a preferable magnetic-layer surface.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A method of deciding a coating condition in manufacturing of a magnetic recording medium by using an extrusion-type coating method of extruding a coating liquid from an end of a slit of a coating head and applying the coating liquid to a continuously-running flexible support while making the flexible support relatively approach the end of the coating head so as to apply a magnetic coating liquid obtained by dispersing magnetic particles in a solvent on the flexible support to form a magnetic- coating-liquid layer, the method comprising the steps of:
evaluating quality of the coating condition in accordance with shearing energy E for unit volume of the magnetic-coating-liquid layer obtained by
$$E = \frac{μ \cdot L \cdot V}{4 \cdot {t}^{ 2}} ,$$
where μ is viscosity (Pa.sec) of the magnetic coating liquid at shearing velocity of 10⁵ sec⁻¹, L is length (m) of a flexible support opposite face at downstream side of the slit at the end of the coating head, V is running velocity (m/sec) of the flexible support, and t is wet-coating thickness (m) of the magnetic-coating-liquid layer; and
deciding the coating condition in accordance with a result of the evaluating step.

2. A magnetic recording medium coated so as to meet a coating condition of shearing energy E>3×10⁶ in accordance with the method of deciding the coating condition according to claim 1.

3. A method of deciding a coating condition in manufacturing of a magnetic recording medium by using an extrusion-type coating method of extruding coating liquids from ends of slits of a coating head and applying the coating liquids to a continuously-running flexible support while making the flexible support relatively approach an end of the coating head so as to apply a non-magnetic coating liquid obtained by dispersing non-magnetic particles in a solvent on the flexible support to form a non-magnetic lower layer and apply, before the non-magnetic lower layer is dried, a magnetic coating liquid obtained by dispersing magnetic particles in a solvent on the non-magnetic lower layer to form a magnetic upper layer, the method comprising the steps of:
evaluating quality of the coating condition in accordance with shearing energy E for unit volume of the magnetic upper layer obtained by
$$\begin{matrix}E = \frac{{μ}_{2} \cdot L \cdot {V}_{c}^{3}}{4 \cdot {t}_{2}^{ 2} \cdot {V}^{2}} , \\ {V}_{c} = \frac{V}{\sqrt{( 1 + α \cdot {t}_{1} / {t}_{2} )}} , and \\ α = {μ}_{2} / {μ}_{1} ,\end{matrix}$$
where μ₁ is viscosity (Pa.sec) of the non-magnetic coating liquid at shearing velocity of 10⁵ sec⁻¹, μ₂ is viscosity (Pa.sec) of the magnetic coating liquid at shearing velocity of 10⁵ sec⁻¹, L is length (m) of a flexible support opposite face at downstream side of the slit discharging the magnetic coating liquid at the end of the coating head, V is running velocity (m/sec) of the flexible support, t₁ is wet-coating thickness (m) of the non-magnetic lower layer, and t₂ is wet-coating thickness (m) of the magnetic upper layer; and
deciding the coating condition in accordance with a result of the evaluation step.

4. A magnetic recording medium coated so as to meet a coating condition of shearing energy E>3×10⁶ in accordance with the method of deciding the coating condition according to claim 3.
